(19) United States
(12) Patent Application Publication
(10) Pub. No.: US 2022/0342411 A1
(43) Pub. Date: Oct. 27, 2022

(54) ABNORMALITY SIGN ESTIMATION DEVICE FOR AIR CONDITIONER, ABNORMALITY SIGN ESTIMATION MODEL LEARNING DEVICE FOR AIR CONDITIONER, AND AIR CONDITIONER

(71) Applicant: Mitsubishi Electric Corporation, Chiyoda-ku, TOKYO (JP)

(72) Inventors: Katsuhiro HIROSE, Chiyoda-ku, TOKYO (JP); Shuichiro SENDA, Chiyoda-ku, TOKYO (JP); Toshihiro ISHIKAWA, Chiyoda-ku, TOKYO (JP)

(21) Appl. No.: 17/763,885

(22) PCT Filed: Dec. 17, 2019
(86) PCT No.: PCT/JP2019/049457

§ 371 Date: Mar. 25, 2022

(51) Int. Cl. G05B 23/02

(52) U.S. Cl. CPC G05B 23/0283

(57) ABSTRACT

An abnormality sign estimation model learning device estimates an abnormality sign degree, for each abnormality type, of an air conditioner provided with an outdoor unit, an indoor unit, and a remote controller. A communication circuit receives a communication frame transmitted between the outdoor unit, the indoor unit, and the remote controller. A communication history storage device stores the received communication frame. A learning data generator generates learning data by using the communication frame stored in communication history storage device. A model generator learns an estimation model for estimation of the abnormality sign degree, for each abnormality type, of the air conditioner by using the generated learning data.

### CROSS REFERENCE TO RELATED APPLICATION

This application is a U.S. National Stage Application of International Patent Application No. PCT/JP2019/049457, filed on Dec. 17, 2019, the disclosure of which is incorporated herein by reference.

### TECHNICAL FIELD

The present disclosure relates to an abnormality sign estimation device for an air conditioner, an abnormality sign estimation model learning device for an air conditioner, and an air conditioner.

### BACKGROUND

In recent years, an abnormality prediction system that predicts occurrence of an abnormality has been used. For example, an abnormality prediction system described in PTL 1 predicts occurrence of an abnormality in equipment from state data indicating a state of the equipment. The abnormality prediction system generates a normal model for estimating state data when normal time from normal data showing the state of an air conditioner when normal time out of past state data. The abnormality prediction system generates a degraded model for estimating state data when abnormal from degraded data showing the state of the air conditioner when abnormal out of the past state data. The abnormality prediction system predicts occurrence of an abnormality in the air conditioner based on a deviation degree between measured data which is measured state data, and estimated normal data led out by the normal model, and a coincidence degree between the measured data and estimated degradation data led out by the degraded model.

### PATENT LITERATURE

PTL 1: Japanese Patent Laying-Open No. 2006-343063

However, in PTL 1, when there are a plurality of types of abnormality, it is not possible to estimate an abnormality sign for each type of abnormality.

### SUMMARY

Therefore, an object of the present disclosure is to provide an abnormality sign estimation device capable of estimating an abnormality sign for each type of abnormality, for an air conditioner, an abnormality sign estimation model learning device for an air conditioner, and an air conditioner.

The present disclosure is an abnormality sign estimation model learning device for an air conditioner including an outdoor unit, an indoor unit, and a remote controller. The abnormality sign estimation model learning device includes: a communication circuit to receive a communication frame transmitted between the outdoor unit, the indoor unit, and the remote controller; a communication history storage device to store the received communication frame; a learning data generator to generate learning data by using a communication frame stored in the communication history storage device; and a model generator to learn an estimation model for estimation of an abnormality sign degree for each abnormality type of the air conditioner by using the generated learning data.

The present disclosure is an abnormality sign estimation device for an air conditioner including an outdoor unit, an indoor unit, and a remote controller. The abnormality sign estimation device includes: a communication circuit to receive a communication frame transmitted between the outdoor unit, the indoor unit, and the remote controller; a communication history storage device to store the received communication frame; an input data generator to generate input data of an estimation model for estimation of an abnormality sign degree for each abnormality type of the air conditioner, by using a communication frame stored in the communication history storage device; and an estimator to estimate an abnormality sign degree for each abnormality type of the air conditioner by using the input data and a learned estimation model.

An air conditioner of the present disclosure includes an outdoor unit, an indoor unit, a remote controller, the above-described abnormality sign estimation model learning device for an air conditioner, and the above-described abnormality sign estimation device for an air conditioner.

According to the present disclosure, it is possible to estimate an abnormality sign for each type of abnormality of an air conditioner.

### BRIEF DESCRIPTION OF DRAWINGS

FIG. 1 is a diagram illustrating a configuration of an air conditioning system 25 according to an embodiment.

FIG. 2 is a diagram illustrating an example of a configuration of an outdoor unit 1.

FIG. 3 is a view illustrating an example of a configuration of an indoor unit 2.

FIG. 4(a) is a view illustrating an example of control information included in a communication frame. FIG. 4(b) is a view illustrating an example of a control state.

FIG. 4(c) is a view illustrating an example of an abnormality type. FIG. 4(d) is a view illustrating an example of a communication frame.

FIG. 5 is a diagram illustrating a configuration of an abnormality sign estimation model learning device 22A.

FIG. 6 is a view illustrating an example of a communication history.

FIG. 7 is a diagram illustrating an example of an abnormality sign estimation model according to a first embodiment.

FIG. 8 is a flowchart illustrating a learning procedure of an abnormality sign estimation model by abnormality sign estimation model learning device 22A.

FIG. 9 is a flowchart illustrating a procedure for learning data generation in the first embodiment.

FIG. 10 is a view illustrating an example of generation of learning data according to the first embodiment.

FIG. 11 is a diagram illustrating a configuration of an abnormality sign estimation device 21A.

FIG. 12 is a flowchart illustrating an abnormality sign degree estimation procedure by abnormality sign estimation device 21A.

FIG. 13 is a flowchart illustrating a procedure for input data generation in the first embodiment.

FIG. 14 is a view illustrating an example of input data generation according to the first embodiment.

FIG. 15 is a diagram illustrating an abnormality sign estimation model according to a second embodiment.

FIG. 16 is a flowchart illustrating a procedure for learning data generation in the second embodiment.

FIG. 17 is a flowchart illustrating a procedure for input data generation in the second embodiment.

FIG. 18 is a diagram illustrating an abnormality sign estimation model according to a third embodiment.

FIG. 19 is a flowchart illustrating a procedure for learning data generation in the third embodiment.

FIG. 20 is a flowchart illustrating a procedure for input data generation in the third embodiment.

FIG. 21 is a diagram illustrating an abnormality sign estimation model according to a fourth embodiment.

FIG. 22 is a flowchart illustrating a procedure for learning data generation in the fourth embodiment.

FIG. 23 is a flowchart illustrating a procedure for input data generation in the fourth embodiment.

FIG. 24 is a diagram illustrating an abnormality sign estimation model according to a fifth embodiment.

FIG. 25 is a flowchart illustrating a procedure for learning data generation in the fifth embodiment.

FIG. 26 is a flowchart illustrating a procedure for input data generation in the fifth embodiment.

FIG. 27 is a diagram illustrating an abnormality sign estimation model according to a sixth embodiment.

FIG. 28 is a flowchart illustrating a procedure for learning data generation in the sixth embodiment.

FIG. 29 is a flowchart illustrating a procedure for input data generation in the sixth embodiment.

FIG. 30 is a diagram illustrating a hardware configuration of an abnormality sign estimation model learning device or an abnormality sign estimation device.

### DETAILED DESCRIPTION

Hereinafter, embodiments will be described with reference to the drawings.

### First Embodiment

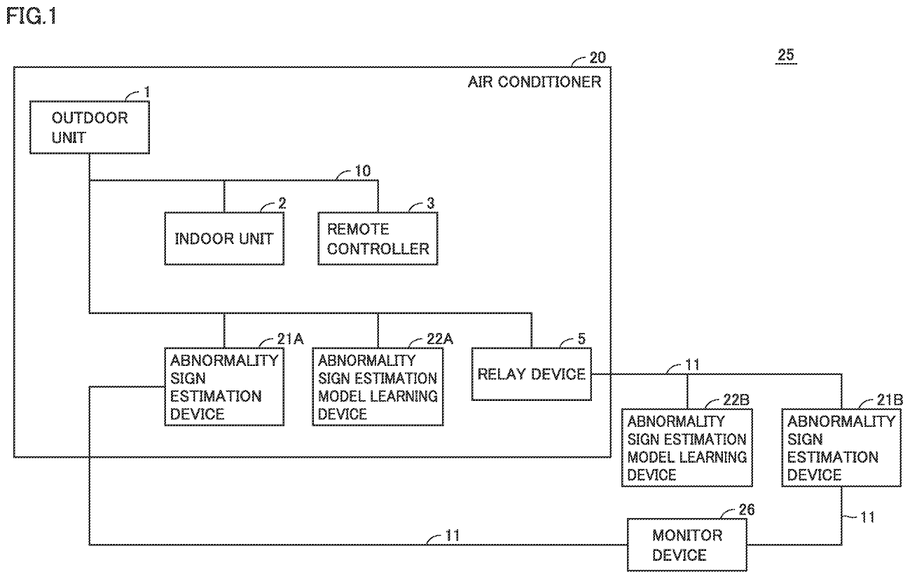

FIG. 1 is a diagram illustrating a configuration of an air conditioning system 25 according to an embodiment.

Air conditioning system 25 includes an air conditioner 20, an abnormality sign estimation model learning device 22B disposed outside air conditioner 20, an abnormality sign estimation device 21B, and a monitor device 26.

Air conditioner 20 includes an indoor unit 2, an outdoor unit 1, a remote controller 3, an abnormality sign estimation model learning device 22A, and an abnormality sign estimation device 21A. These components in air conditioner 20 are connected by a first communication network 10.

A relay device 5, abnormality sign estimation model learning device 22B outside, abnormality sign estimation device 21B, and monitor device 26 are connected by a second communication network 11. Abnormality sign estimation device 21A inside and monitor device 26 are connected by second communication network 11. Second communication network 11 is, for example, the Internet or the like. Although not illustrated, second communication network 11 is connected to an abnormality sign estimation model learning device 22 and an abnormality sign estimation device 21 of another air conditioner 20.

Monitor device 26 notifies a user of a sign degree of each abnormality type.

Although not illustrated, a plurality of outdoor units 1, a plurality of indoor units 2, and a plurality of remote controllers 3 may be connected.

Remote controller 3 receives an operation from the user and transmits a control signal to outdoor unit 1 and indoor unit 2. Outdoor unit 1 and indoor unit 2 execute control such as cooling operation or heating operation in accordance with a control signal received from remote controller 3. When remote controller 3 receives a communication frame notifying of an abnormality of the air conditioner from outdoor unit 1 or indoor unit 2, remote controller 3 displays the abnormality on an operation screen.

Outdoor unit 1 and indoor unit 2 perform cooperative control by communicating a signal indicating a control state of a refrigeration cycle.

Abnormality sign estimation model learning device 22A receives a communication frame transmitted between outdoor unit 1, indoor unit 2, and remote controller 3 in air conditioner 20. By using the received communication frame, abnormality sign estimation device 21A learns an abnormality sign estimation model for estimation of an abnormality sign degree for each abnormality type.

Abnormality sign estimation device 21A receives a communication frame transmitted between outdoor unit 1, indoor unit 2, and remote controller 3 in air conditioner 20. Abnormality sign estimation device 21A estimates an abnormality sign degree for each abnormality type, by using the acquired communication frame and the learned abnormality sign estimation model. Abnormality sign estimation device 21A transmits a signal for notifying of a sign degree of each abnormality type, to monitor device 26 through second communication network 11. Abnormality sign estimation device 21A executes control for abnormality avoidance for each abnormality type.

Abnormality sign estimation model learning device 22B and abnormality sign estimation device 21B acquire a communication frame transmitted into air conditioner 20, through relay device 5 and second communication network 11. Functions of abnormality sign estimation model learning device 22B and abnormality sign estimation device 21B are substantially similar to functions of abnormality sign estimation model learning device 22A and abnormality sign estimation device 21A, respectively.

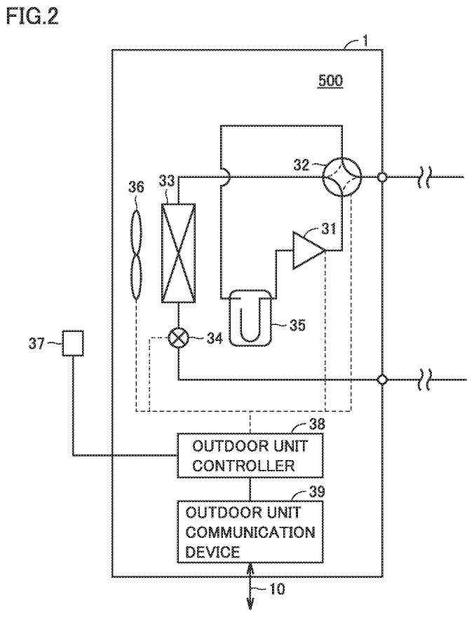

FIG. 2 is a diagram illustrating an example of a configuration of outdoor unit 1.

Outdoor unit 1 includes a compressor 31, an outdoor-unit-side heat exchanger 33, a four-way switching valve 32, an accumulator 35, an outdoor-unit-side expansion valve 34, an outdoor-unit-side fan 36, an outdoor unit temperature sensor 37, an outdoor unit controller 38, and an outdoor unit communication device 39.

Compressor 31 compresses a suctioned refrigerant (gas). Compressor 31 may be an inverter compressor capable of freely changing an operating frequency.

Outdoor-unit-side heat exchanger 33 exchanges heat between a refrigerant and air.

Outdoor-unit-side fan 36 sends air for heat exchange to outdoor-unit-side heat exchanger 33.

Four-way switching valve 32 switches a flow path of the refrigerant in accordance with cooling operation or heating operation.

Accumulator 35 stores a liquid refrigerant to cause only a gas refrigerant to be suctioned into compressor 31.

By adjusting an opening degree of outdoor-unit-side expansion valve 34, a flow rate of the refrigerant is controlled.

Outdoor unit temperature sensor 37 detects a temperature around outdoor unit 1. Outdoor unit temperature sensor 37 transmits a signal indicating the temperature to outdoor unit controller 38.

Outdoor unit controller 38 controls operation of components of outdoor unit 1 in accordance with a signal from outdoor unit temperature sensor 37, a communication frame addressed to outdoor unit 1 and received from indoor unit 2 or remote controller 3 through first communication network 10, and the like. Outdoor unit controller 38 determines an abnormality and a type of the abnormality of air conditioner 20. When outdoor unit controller 38 determines an abnormality of air conditioner 20, outdoor unit controller 38 transmits a communication frame notifying indoor unit 2 of the abnormality, and controls a refrigerant circuit 500 to stop the operation of outdoor unit 1. Outdoor unit controller 38 can be configured by a main processor.

Outdoor unit communication device 39 is connected to first communication network 10. Outdoor unit communication device 39 receives a communication frame from indoor unit 2 or remote controller 3 through first communication network 10. Outdoor unit communication device 39 transmits a communication frame to indoor unit 2 or remote controller 3 through first communication network 10. Outdoor unit communication device 39 can be configured by a communication processor.

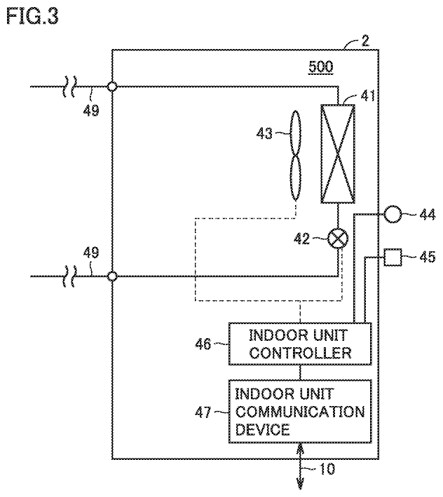

FIG. 3 is a diagram illustrating an example of a configuration of indoor unit 2.

Indoor unit 2 includes an indoor-unit-side heat exchanger 41, an indoor-unit-side fan 43, an indoor-unit-side expansion valve 42, an indoor unit temperature sensor 45, an indoor unit humidity sensor 44, an indoor unit controller 46, and an indoor unit communication device 47.

Indoor-unit-side heat exchanger 41 exchanges heat between a refrigerant and air.

Indoor-unit-side fan 43 sends air to indoor-unit-side heat exchanger 41.

By adjusting an opening degree of indoor-unit-side expansion valve 42, a flow rate of the refrigerant is controlled.

Indoor unit temperature sensor 45 detects a temperature in a room in which indoor unit 2 is provided.

Indoor unit humidity sensor 44 detects humidity in the room.

Indoor unit temperature sensor 45 and indoor unit humidity sensor 44 transmit signals representing a temperature and a humidity to indoor unit controller 46, respectively.

Indoor unit controller 46 controls operation of components of indoor unit 2 in accordance with signals from indoor unit temperature sensor 45 and indoor unit humidity sensor 44, a communication frame addressed to indoor unit 2 and received from outdoor unit 1 or remote controller 3 through first communication network 10, and the like. Indoor unit controller 46 determines an abnormality and a type of the abnormality of air conditioner 20. When indoor unit controller 46 determines an abnormality of air conditioner 20, indoor unit controller 46 transmits a communication frame notifying outdoor unit 1 of the abnormality, and controls refrigerant circuit 500 to stop the operation of indoor unit 2. Indoor unit controller 46 can be configured by a main processor.

Indoor unit communication device 47 is connected to first communication network 10. Indoor unit communication device 47 receives a communication frame from outdoor unit 1 or remote controller 3 through first communication network 10. Indoor unit communication device 47 transmits a communication frame to outdoor unit 1 or remote controller 3 through first communication network 10. Indoor unit communication device 47 can be configured by a communication processor.

Compressor 31, four-way switching valve 32, outdoor-unit-side heat exchanger 33, outdoor-unit-side expansion valve 34, indoor-unit-side expansion valve 42, indoor-unit-side heat exchanger 41, and the accumulator constitute refrigerant circuit 500 through which the refrigerant circulates.

The communication frame transmitted through first communication network 10 includes destination information and control information.

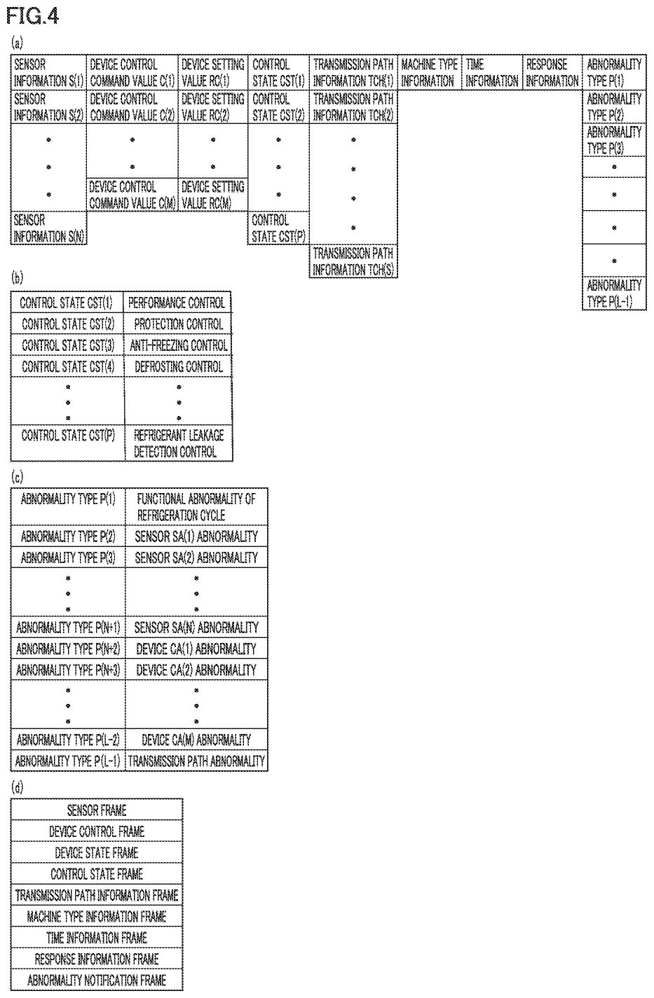

FIG. 4(a) is a view illustrating an example of control information included in a communication frame.

The control information includes: sensor information S(1) to S(N); device control command values C(1) to C(M); device setting values RC(1) to RC(M); control states CST(1) to CST(P); transmission path information TCH(1) to TCH(S); machine type information; time information; response information; and abnormality types P(1) to P(L−1).

A sensor information S(i) represents a detection value obtained by a sensor SA(i). Sensor SA(i) is any one of outdoor unit temperature sensor 37, indoor unit temperature sensor 45, indoor unit humidity sensor 44, and other sensors (not illustrated).

A device control command value C(i) represents a control command value for a device AC(i). Device AC(i) is any one of compressor 31, outdoor-unit-side fan 36, outdoor-unit-side expansion valve 34, indoor-unit-side fan 43, indoor-unit-side expansion valve 42, and other devices (not illustrated).

A device setting value RC(i) represents a value that is set in accordance with a control command value to device AC(i).

Control states CST(1) to CST(P) represent control states of the air conditioner.

FIG. 4(b) is a view illustrating an example of a control state.

Control state CST(1) represents performance control. The performance control corresponds to, for example, control of a rotation frequency of compressor 31 to cause an indoor temperature to follow a set temperature that is set by remote controller 3. Control state CST(2) represents protection control. The protection control corresponds to control of an expansion valve opening degree, a rotation speed of a fan, a refrigerant temperature, a refrigerant pressure, and the like of indoor unit 2 so that the refrigerant can be sufficiently evaporated in indoor unit 2 at the time of cooling, for example, in order to prevent compressor 31 from failing due to liquid back. Control state CST(3) represents anti-freezing control. The anti-freezing control corresponds to, for example, control for preventing outdoor-unit-side heat exchanger 33 of outdoor unit 1 from being frozen.

Control state CST(4) represents defrosting control. The defrosting control corresponds to, for example, control of indoor-unit-side fan 43 or the like to remove frost adhering to indoor-unit-side heat exchanger 41. Control state CST(P) represents refrigerant leakage detection control. The refrigerant leakage detection control corresponds to, for example, control for switching a refrigerant flow path in order to detect a refrigerant leakage from the refrigerant circuit. Outdoor unit 1 and indoor unit 2 can perform cooperative control by sharing the control state by the communication frame between outdoor unit 1 and indoor unit 2.

Transmission path information TCH(1) to TCH(S) indicate states of first communication network 10 that is a transmission path. Transmission path information TCH(1) is a voltage value applied to a transmission path. Transmission path information TCH(2) to TCH(S) are sample values of a waveform of a received communication frame for every certain period of time. A state of the first communication network can be detected by outdoor unit communication device 39 and indoor unit communication device 47.

The machine type information indicates a machine type such as a machine type name, a production number, and a software version of air conditioner 20.

The time information represents a current time.

The response information is a positive response (ACK), a negative response (NACK), or the like to a command.

Abnormality types P(1) to P(L−1) include codes representing types of abnormality.

FIG. 4(c) is a view illustrating an example of an abnormality type.

Abnormality type P(1) represents a functional abnormality of the refrigeration cycle. Outdoor unit controller 38 and indoor unit controller 46 can detect the functional abnormality of the refrigeration cycle.

Abnormality types P(2) to P(N+1) represent abnormalities of sensors SA(1) to SA(N). Outdoor unit controller 38 and indoor unit controller 46 can detect that sensors SA(1) to SA(N) are abnormal when detection values of sensors SA(1) to SA(N) are out of a preset normal value range.

Abnormality types P(N+2) to P(L−2) represent abnormalities of devices CA(1) to CA(M). For example, when outdoor unit controller 38 transmits a communication frame including device control command value C(i) to indoor unit 2 and receives a communication frame including device setting value RC(i) and transmitted from indoor unit 2, outdoor unit controller 38 can determine that a device CA(i) is abnormal when a difference between device control command value C(i) and device setting value RC(i) is greater than or equal to a specified value. Alternatively, when indoor unit controller 46 transmits a communication frame including device control command value C(i) to outdoor unit 1 and receives a communication frame including device setting value RC(i) and transmitted from outdoor unit 1, indoor unit controller 46 can determine that device CA(i) is abnormal when a difference between device control command value C(i) and device setting value RC(i) is greater than or equal to a specified value.

Abnormality type P(L−1) represents an abnormality of a transmission path (first communication network 10). For example, when controllers of outdoor unit controller 38, indoor unit controller 46, and remote controller 3 transmit a communication frame including device control command value C(i) and do not receive a communication frame including response information within a specified time, it is determined that the transmission path is abnormal.

FIG. 4(d) is a view illustrating an example of a communication frame.

Outdoor unit 1 can transmit a sensor frame including sensor information S(i), with a destination set to indoor unit 2 or remote controller 3. Indoor unit 2 can transmit a sensor frame including sensor information S(i), with a destination set to outdoor unit 1 or remote controller 3.

Outdoor unit 1 can transmit a device control frame including device control command value C(i), with a destination set to indoor unit 2 or remote controller 3. Indoor unit 2 can transmit a device control frame including device control command value C(i), with a destination set to outdoor unit 1 or remote controller 3. Remote controller 3 can transmit a device control frame including device control command value C(i), with a destination set to outdoor unit 1 or indoor unit 2.

Outdoor unit 1 can transmit a device state frame including device setting value RC(i), with a destination set to indoor unit 2 or remote controller 3. Indoor unit 2 can transmit a device state frame including device setting value RC(i), with a destination set to outdoor unit 1 or remote controller 3.

Outdoor unit 1 can transmit a control state frame including a control state, with a destination set to indoor unit 2 or remote controller 3. Indoor unit 2 can transmit a control state frame including a control state, with a destination set to outdoor unit 1 or remote controller 3.

Outdoor unit 1 can transmit a transmission path information frame including transmission path information, with a destination set to indoor unit 2 or remote controller 3. Indoor unit 2 can transmit a transmission path information frame including transmission path information, with a destination set to outdoor unit 1 or remote controller 3.

Outdoor unit 1 can transmit a machine type information frame including machine type information, with a destination set to indoor unit 2 or remote controller 3. Indoor unit 2 can transmit a machine type information frame including machine type information, with a destination set to outdoor unit 1 or remote controller 3. Remote controller 3 can transmit a machine type information frame including machine type information, with a destination set to outdoor unit 1 or indoor unit 2. The machine type information frame may be transmitted, for example, when air conditioner 20 is installed.

Outdoor unit 1 can transmit a time information frame including time information, with a destination set to indoor unit 2 or remote controller 3. Indoor unit 2 can transmit a time information frame including time information, with a destination set to outdoor unit 1 or remote controller 3. Remote controller 3 can transmit a time information frame including time information, with a destination set to outdoor unit 1 or indoor unit 2. For example, the time information frame may be transmitted when air conditioner 20 is installed. Alternatively, the time information frame may be transmitted for time adjustment between outdoor unit 1, indoor unit 2, and remote controller 3 at a constant cycle.

Outdoor unit 1 can transmit a response information frame including response information, with a destination set to indoor unit 2 or remote controller 3. Indoor unit 2 can transmit a response information frame including response information, with a destination set to outdoor unit 1 or remote controller 3. Remote controller 3 can transmit a response information frame including response information, with a destination set to outdoor unit 1 or indoor unit 2.

When outdoor unit 1 detects an abnormality, outdoor unit 1 can transmit an abnormality notification frame including an abnormality type, with a destination set to indoor unit 2 or remote controller 3. When indoor unit 2 detects an abnormality, indoor unit 2 can transmit an abnormality notification frame including an abnormality type, with a destination set to outdoor unit 1 or remote controller 3.

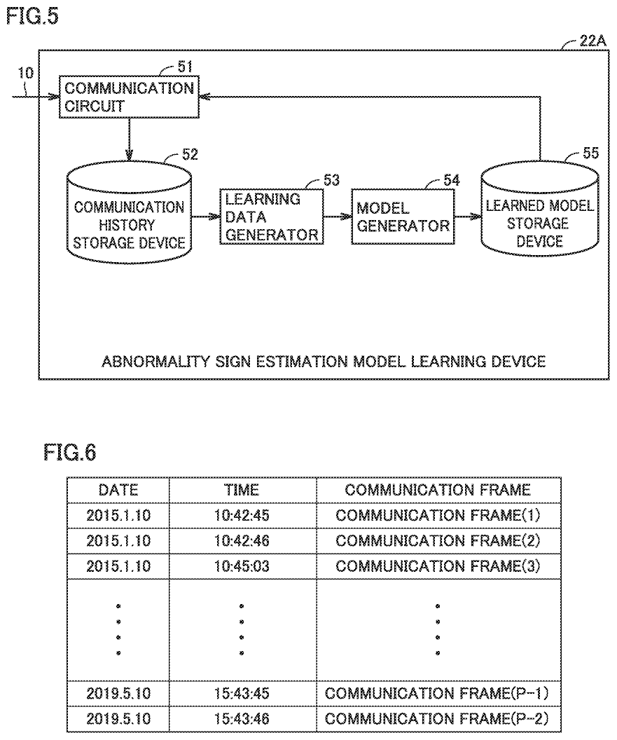

FIG. 5 is a diagram illustrating a configuration of abnormality sign estimation model learning device 22A.

Abnormality sign estimation model learning device 22A includes a communication circuit 51, a communication history storage device 52, a learning data generator 53, a model generator 54, and a learned model storage device 55.

Communication circuit 51 receives a communication frame transmitted through first communication network 10 regardless of the destination.

As illustrated in FIG. 6, communication history storage device 52 stores a communication history including a date and time when a communication frame is received and the received communication frame.

Learning data generator 53 generates learning data by using the communication frame and the reception date and time stored in communication history storage device 52.

Model generator 54 uses the generated learning data to learn an abnormality sign degree estimation model for estimation of an abnormality sign degree of each abnormality type of air conditioner 20.

As a learning algorithm used by model generator 54, a known algorithm such as supervised learning, unsupervised learning, or reinforcement learning can be used. Hereinafter, as an example, a case where a neural network is applied will be described.

Model generator 54 uses supervised learning based on a neural network model. Here, in the supervised learning, by giving a large number of sets of a certain input and result (label) data to a learning device, features in learning data of these are learned, and a result is estimated from the input.

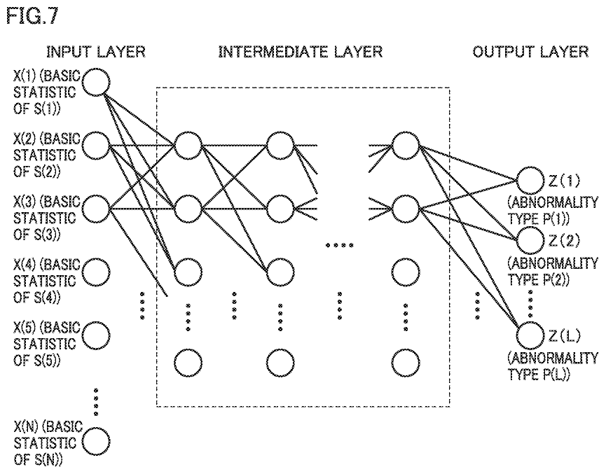

FIG. 7 is a diagram illustrating an example of an abnormality sign estimation model according to a first embodiment.

A neural network includes an input layer including a plurality of neurons, an intermediate layer (hidden layer) including a plurality of neurons, and an output layer including a plurality of neurons. The intermediate layer may be one layer or may be greater than or equal to two layers.

To an i-th unit of the input layer, input data X(i) is given. From an i-th unit of the output layer, output data Z(i) is outputted.

In the abnormality sign estimation model of the first embodiment, input data X(1) to X(N) to be inputted to the input layer are basic statistics of sensor information S(1) to S(N).

A size of output data Z(i) outputted from the output layer is greater than or equal to 0 and less than or equal to 1.

Output data Z(1) to Z(L) are sign degrees of abnormality types P(1) to P(L), that is, likelihood of occurrence. However, abnormality type P(L) represents a probability of “absence of abnormality”.

A detection value of a sensor varies or becomes an abnormal value by mixing of noise into a detection signal due to aging deterioration of the sensor. Therefore, a variance value of the detection value of the sensor in which the aging deterioration progresses is large, and an average value is out of a normal value range.

Therefore, by inputting a basic statistic of the detection value of the sensor to the input layer of the abnormality sign estimation model, estimation accuracy of abnormality sign degree estimation can be increased.

Learned model storage device 55 stores information indicating a learned abnormality sign estimation model. The information indicating the learned abnormality sign estimation model is a weighting coefficient of the neural network. The information indicating the learned abnormality sign estimation model can be transmitted to abnormality sign estimation device 21A or relay device 5 through first communication network 10 by communication circuit 51. Relay device 5 can transmit information indicating the received learned abnormality sign estimation model to abnormality sign estimation device 21B or an abnormality sign estimation device for another air conditioner (not illustrated) through second communication network 11.

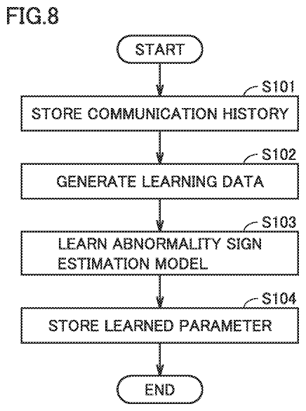

FIG. 8 is a flowchart illustrating a learning procedure of an abnormality sign estimation model by abnormality sign estimation model learning device 22A.

In step S101, communication circuit 51 receives a communication frame through first communication network 10. Communication circuit 51 causes communication history storage device 52 to store a communication history including the communication frame and a date and time when the communication frame is received.

In step S102, learning data generator 53 generates learning data by using the communication history stored in communication history storage device 52.

In step S103, model generator 54 learns an abnormality sign estimation model by using the generated learning data.

In step S104, model generator 54 causes learned model storage device 55 to store information indicating the learned abnormality sign estimation model.

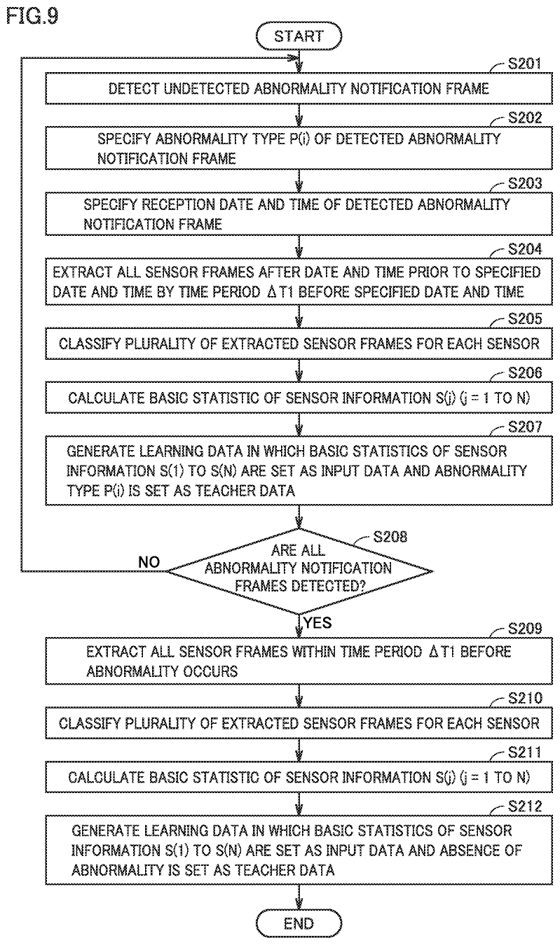

FIG. 9 is a flowchart illustrating a procedure for learning data generation in the first embodiment.

In step S201, learning data generator 53 detects an undetected abnormality notification frame among communication frames stored in communication history storage device 52.

In step S202, learning data generator 53 specifies an abnormality type included in the detected abnormality notification frame. The specified abnormality type is defined as abnormality type P(i). i=any of 1 to (L−1).

In step S203, learning data generator 53 specifies a date and time when the detected abnormality notification frame is received.

In step S204, learning data generator 53 extracts all the sensor frames after a date and time prior to the specified date and time by a time period ΔT1 before the specified date and time, among the communication frames stored in communication history storage device 52.

In step S205, learning data generator 53 classifies, for each sensor, sensor information included in the plurality of extracted sensor frames.

In step S206, learning data generator 53 calculates a basic statistic of sensor information S(j). Here, j=1 to N.

In step S207, learning data generator 53 generates learning data in which the basic statistics of sensor information S(1) to S(N) are set as input data X(1) to X(N) to be inputted to the input layer of the abnormality sign estimation model, and specified abnormality type P(i) is set as teacher data of the abnormality sign estimation model.

In a case where all the abnormality notification frames of the communication frames stored in communication history storage device 52 are detected in step S208, the process proceeds to step S209. In a case where there is an undetected communication frame, the process returns to step S201.

In step S209, learning data generator 53 extracts, from the communication frames stored in communication history storage device 52, all the sensor frames within time period ΔT1 before the abnormality occurs, that is, before the first abnormality notification frame is received.

In step S210, learning data generator 53 classifies, for each sensor, sensor information included in the plurality of extracted sensor frames.

In step S211, learning data generator 53 calculates a basic statistic of sensor information S(j). Here, j=1 to N.

In step S212, learning data generator 53 generates learning data in which the basic statistics of sensor information S(1) to S(N) are set as input data X(1) to X(N) to be inputted to the input layer of the abnormality sign estimation model, and absence of abnormality is set as teacher data of the abnormality sign estimation model.

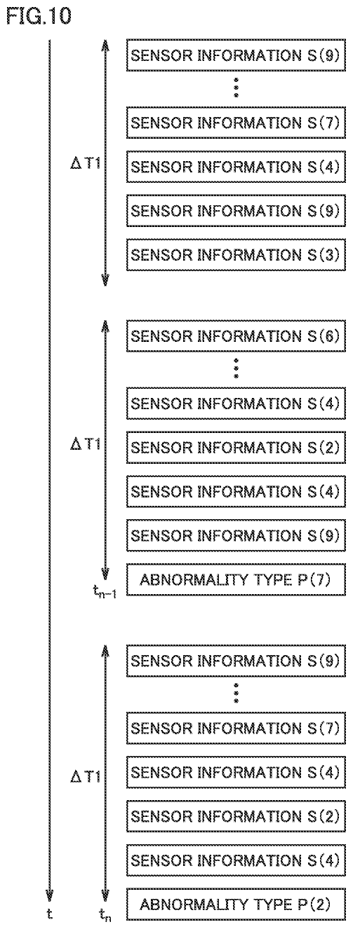

FIG. 10 is a view illustrating an example of generation of learning data according to the first embodiment.

When an abnormality notification frame including abnormality type P(2) is detected, a plurality of sensor frames among the communication frames from (tₙ−ΔT1) to tₙ are extracted since the reception date and time of the abnormality notification frame is tₙ. The plurality of extracted sensor frames are classified for each sensor corresponding to sensor information. For example, basic statistics of a plurality of pieces of sensor information S(1) are calculated. Basic statistics are similarly calculated for sensor information S(2) to S(N). Learning data is generated in which N pieces of the calculated basic statistics are set as input data and abnormality type P(2) is set as teacher data.

When an abnormality notification frame including abnormality type P(7) is detected, a plurality of sensor frames among the communication frames from (tₙ₋₁−ΔT1) to tₙ₋₁ are extracted since the reception date and time of the abnormality notification frame is tₙ₋₁. The plurality of extracted sensor frames are classified for each sensor corresponding to sensor information. For example, basic statistics of a plurality of pieces of sensor information S(1) are calculated. Basic statistics are similarly calculated for sensor information S(2) to S(N). Learning data is generated in which N pieces of the calculated basic statistics are set as input data and abnormality type P(7) is set as teacher data.

A plurality of sensor frames within time period ΔT1 before occurrence of an abnormality are extracted. The plurality of extracted sensor frames are classified for each sensor corresponding to sensor information. For example, basic statistics of a plurality of pieces of sensor information S(1) are calculated. Basic statistics are similarly calculated for sensor information S(2) to S(N). Learning data is generated in which N pieces of the calculated basic statistics are set as input data and absence of abnormality is set as teacher data.

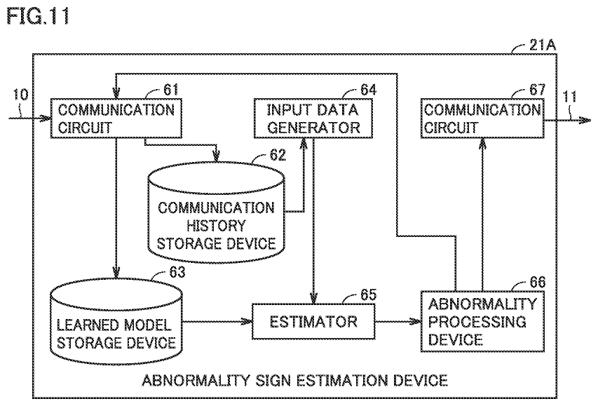

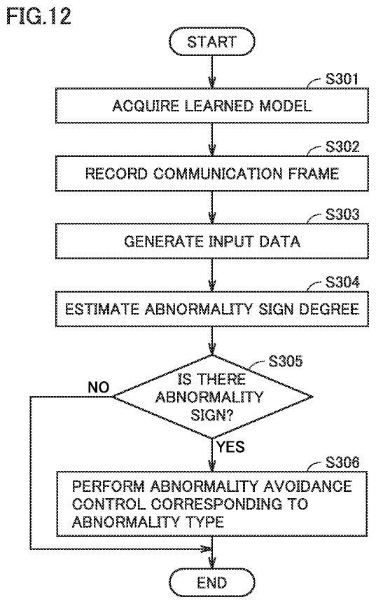

FIG. 11 is a diagram illustrating a configuration of abnormality sign estimation device 21A.

Abnormality sign estimation device 21A includes a communication circuit 61, a communication history storage device 62, a learned model storage device 63, an input data generator 64, an estimator 65, an abnormality processing device 66, and a communication circuit 67.

Communication circuit 61 receives a communication frame and information indicating a learned abnormality sign estimation model through first communication network 10 regardless of the destination. Communication circuit 61 transmits information regarding an abnormality handling process transmitted from abnormality processing device 66, through first communication network 10.

Communication history storage device 62 stores a communication history including a date and time when a communication frame is received and the received communication frame.

Learned model storage device 63 stores information indicating the learned abnormality sign estimation model and received by communication circuit 61. The information indicating the learned abnormality sign estimation model is a weighting coefficient of the neural network. Learned model storage device 63 may store information received by communication circuit 67 and indicating a learned abnormality sign estimation model that is learned by an abnormality sign estimation model learning device for another air conditioner.

Input data generator 64 generates input data to the learned abnormality sign estimation model by using a communication frame and a reception date and time stored in communication history storage device 62.

Estimator 65 estimates an abnormality sign degree of each abnormality type of air conditioner 20, by using the learned abnormality sign estimation model and the generated input data.

When an abnormality sign is estimated, abnormality processing device 66 executes abnormality avoidance control according to the abnormality type. As a result, the time when the abnormality of air conditioner 20 becomes real can be extended, and the service life of air conditioner 20 can be extended.

For example, abnormality processing device 66 controls outdoor unit 1 and indoor unit 2 so as to perform operation with a reduced load. For example, when there is a high sign degree of an abnormality type of a functional abnormality of the refrigeration cycle, outdoor unit 1 and indoor unit 2 are controlled to reduce air conditioning performance in operation of air conditioner 20. Abnormality processing device 66 may perform control such as lowering a set temperature during cooling, or operating only one of a plurality of indoor units in air conditioner 20 and stopping the rest of the indoor units. Alternatively, abnormality processing device 66 notifies a user, an agent, or a contractor of a sign for each abnormality type by e-mail. This makes it possible to urge these persons to perform maintenance of air conditioner 20. As a result, maintenance can be performed at an appropriate time.

Alternatively, abnormality processing device 66 causes remote controller 3 in air conditioner 20 or a device connected to air conditioner 20 to display a sign for each abnormality type. Alternatively, abnormality processing device 66 causes remote controller 3 in air conditioner 20 or a device connected to air conditioner 20 to notify of a sign for each abnormality type with sound. Alternatively, abnormality processing device 66 may execute abnormality avoidance control for each abnormality type. Alternatively, although not illustrated, processing of the abnormality avoidance control of abnormality processing device 66 may be externally settable through first communication network 10 or second communication network 11. This allows the user to set a processing content of the abnormality avoidance control by remote control operation, or the user to set a processing content of the abnormality avoidance control by smartphone operation or the like via a cloud.

Communication circuit 67 transmits information related to the abnormality avoidance control and transmitted from abnormality processing device 66, through second communication network 11.

FIG. 12 is a flowchart illustrating an abnormality sign degree estimation procedure by abnormality sign estimation device 21A.

In step S301, communication circuit 61 receives information indicating a learned abnormality sign estimation model through first communication network 10, and causes learned model storage device 63 to store the information.

In step S302, communication circuit 61 receives a communication frame through first communication network 10. Communication circuit 61 causes communication history storage device 62 to store a communication history including the communication frame and a date and time when the communication frame is received.

In step S303, input data generator 64 generates input data to be inputted to the learned abnormality sign estimation model, by using the communication history stored in communication history storage device 62.

In step S304, estimator 65 estimates an abnormality sign degree of each abnormality type of air conditioner 20, by using the learned abnormality sign estimation model and the generated input data.

In a case where an abnormality sign is estimated in step S305, the process proceeds to step S306.

In step S306, abnormality processing device 66 executes abnormality avoidance control according to the abnormality type.

FIG. 13 is a flowchart illustrating a procedure for input data generation in the first embodiment.

In step S401, input data generator 64 extracts all the sensor frames after a date and time prior to a current date and time by a time period ΔT2 before the current date and time, among the communication frames stored in communication history storage device 52.

In step S402, input data generator 64 classifies, for each sensor, sensor information included in the plurality of extracted sensor frames.

In step S403, input data generator 64 calculates a basic statistic of sensor information S(j). Here, j=1 to N.

In step S404, input data generator 64 sets the basic statistics of sensor information S(1) to S(N) as input data X(1) to X(N) to be inputted to the input layer of the abnormality sign estimation model.

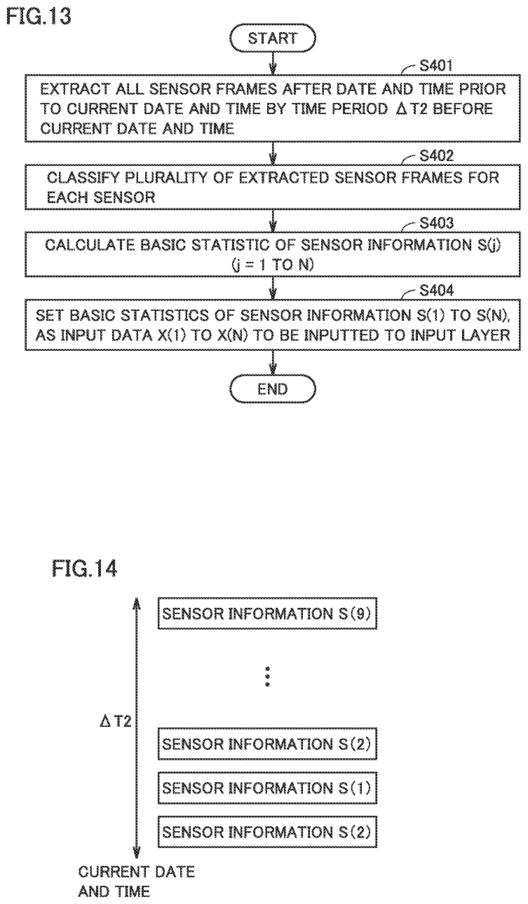

FIG. 14 is a view illustrating an example of input data generation according to the first embodiment.

A plurality of sensor frames after a date and time prior to the current date and time by a time period ΔT2 before the current date and time are extracted. The plurality of extracted sensor frames are classified for each sensor corresponding to sensor information. For example, basic statistics of a plurality of pieces of sensor information S(1) are calculated. Basic statistics are similarly calculated for sensor information S(2) to S(N). N pieces of the calculated basic statistics are set as input data to be inputted to the input layer of the abnormality sign estimation model.

According to the present embodiment, by using the abnormality sign estimation model in which the basic statistics of sensor information S(1) to S(N) are set as input and abnormality sign degrees of abnormality types P(1) to P(L) are set as output, the abnormality sign degree for each abnormality type can be estimated.

### Second Embodiment

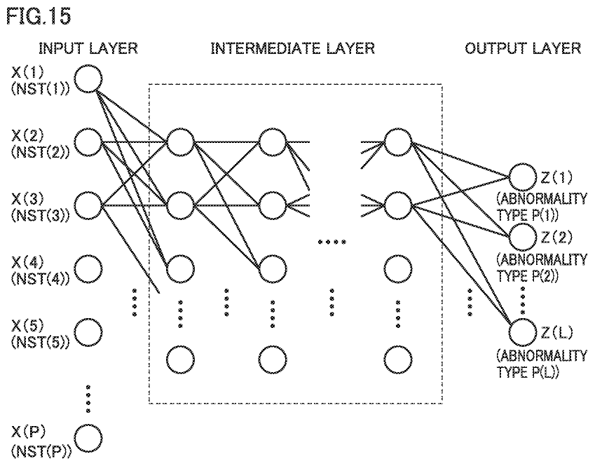

FIG. 15 is a diagram illustrating an abnormality sign estimation model according to a second embodiment.

In the abnormality sign estimation model of the present embodiment, input data X(1) to X(L) to be inputted to an input layer are total numbers NST(1) to NST(P) of control states CST(1) to CST(P) included in control state frames within a certain period of time.

At abnormal time of an air conditioner 20, a control state changes more than at normal time. When the control state changes, a control state frame is transmitted to notify other devices of the change. Therefore, when there are many changes in the control state, the total number of control state frames included in a certain period of time tends to increase. Therefore, by inputting the total number of control state frames included in a certain period of time to an input layer of the abnormality sign estimation model, an estimation accuracy of an abnormality sign can be improved. However, one control state frame may include information on a plurality of control states. Therefore, by inputting total numbers NST(1) to NST(P) of control states CST(1) to CST(P) included in a communication frame within a certain period of time to the input layer of the abnormality sign estimation model, it is possible to improve the estimation accuracy of the abnormality sign.

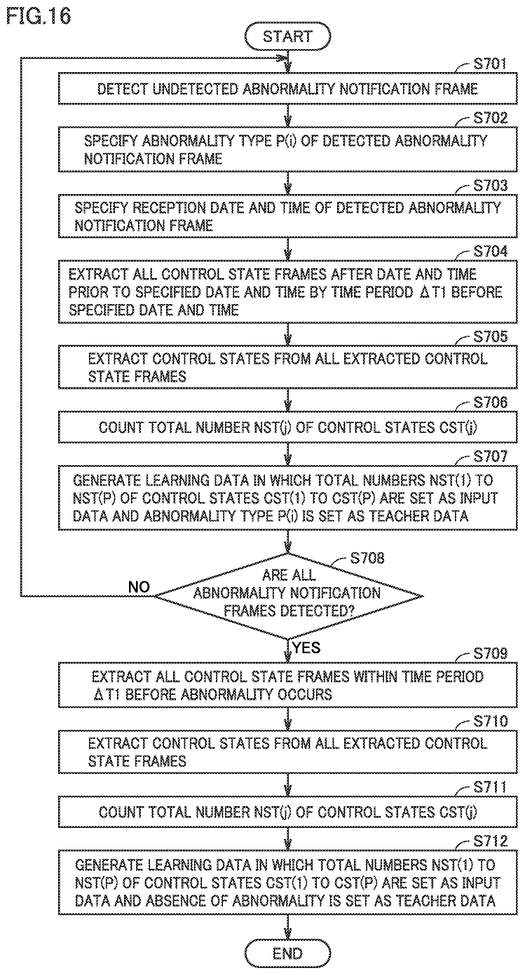

FIG. 16 is a flowchart illustrating a procedure for learning data generation in the second embodiment.

In step S701, a learning data generator 53 detects an undetected abnormality notification frame among communication frames stored in a communication history storage device 52.

In step S702, learning data generator 53 specifies an abnormality type included in the detected abnormality notification frame. The specified abnormality type is defined as abnormality type P(i). i=any of 1 to (L−1).

In step S703, learning data generator 53 specifies a date and time when the detected abnormality notification frame is received.

In step S704, learning data generator 53 extracts all the control state frames after a date and time prior to the specified date and time by a time period ΔT1 before the specified date and time, among the communication frames stored in communication history storage device 52.

In step S705, learning data generator 53 extracts control states from all the extracted control state frames.

In step S706, learning data generator 53 counts a total number NST(j) of control states CST(j). Here, j=1 to P.

In step S707, learning data generator 53 generates learning data in which total numbers NST(1) to NST(P) of control states CST(1) to CST(P) are set as input data X(1) to X(P) to be inputted to the input layer of the abnormality sign estimation model, and specified abnormality type P(i) is set as teacher data of the abnormality sign estimation model.

In a case where all the abnormality notification frames of the communication frames stored in communication history storage device 52 are detected in step S708, the process proceeds to step S709. In a case where there is an undetected communication frame, the process returns to step S701.

In step S709, learning data generator 53 extracts, from the communication frames stored in communication history storage device 52, all the control state frames within time period ΔT1 before the abnormality occurs, that is, before the first abnormality notification frame is received.

In step S710, learning data generator 53 extracts control states from all the extracted control state frames.

In step S711, learning data generator 53 counts total number NST(j) of control states CST(j). Here, j=1 to P.

In step S712, learning data generator 53 generates learning data in which total numbers NST(1) to NST(P) of control states CST(1) to CST(P) are set as input data X(1) to X(P) to be inputted to the input layer of the abnormality sign estimation model, and absence of abnormality is set as teacher data of the abnormality sign estimation model.

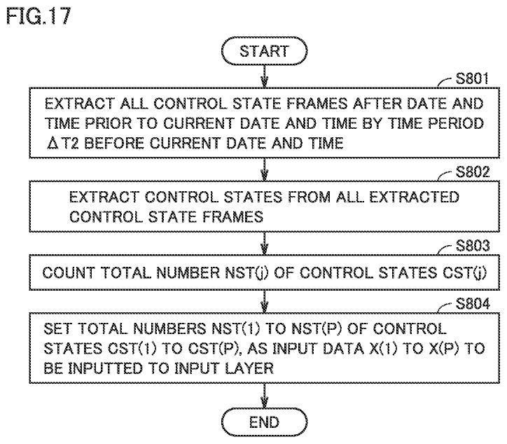

FIG. 17 is a flowchart illustrating a procedure for input data generation in the second embodiment.

In step S801, an input data generator 64 extracts all the control state frames after a date and time prior to a current date and time by a time period ΔT2 before the current date and time, among the communication frames stored in communication history storage device 52.

In step S802, input data generator 64 extracts control states from all the extracted control state frames.

In step S803, input data generator 64 counts total number NST(j) of control states CST(j). Here, j=1 to P.

In step S804, input data generator 64 sets total numbers NST(1) to NST(P) of control states CST(1) to CST(P) as input data X(1) to X(P) to be inputted to the input layer of the abnormality sign estimation model.

According to the present embodiment, by using the abnormality sign estimation model in which total numbers NST(1) to NST(P) of control states CST(1) to CST(P) included in control state frames within a certain period of time are set as input and abnormality sign degrees of abnormality types P(1) to P(L) are set as output, the abnormality sign degree for each abnormality type can be estimated.

### Third Embodiment

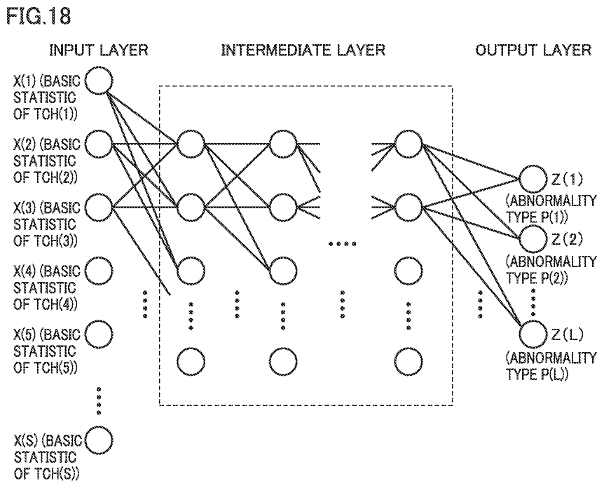

FIG. 18 is a diagram illustrating an abnormality sign estimation model according to a third embodiment.

In the abnormality sign estimation model of the present embodiment, input data X(1) to X(S) to be inputted to an input layer are basic statistics of transmission path information TCH(1) to TCH(S).

As aging deterioration progresses, a voltage applied to a transmission path decreases, and a degree of distortion of a waveform of a signal transmitted to the transmission path also increases due to application of noise. Therefore, by inputting basic statistics of transmission path information TCH(1) to TCH(S) to the input layer of the abnormality sign estimation model, it is possible to estimate an abnormality caused by aging deterioration of the transmission path.

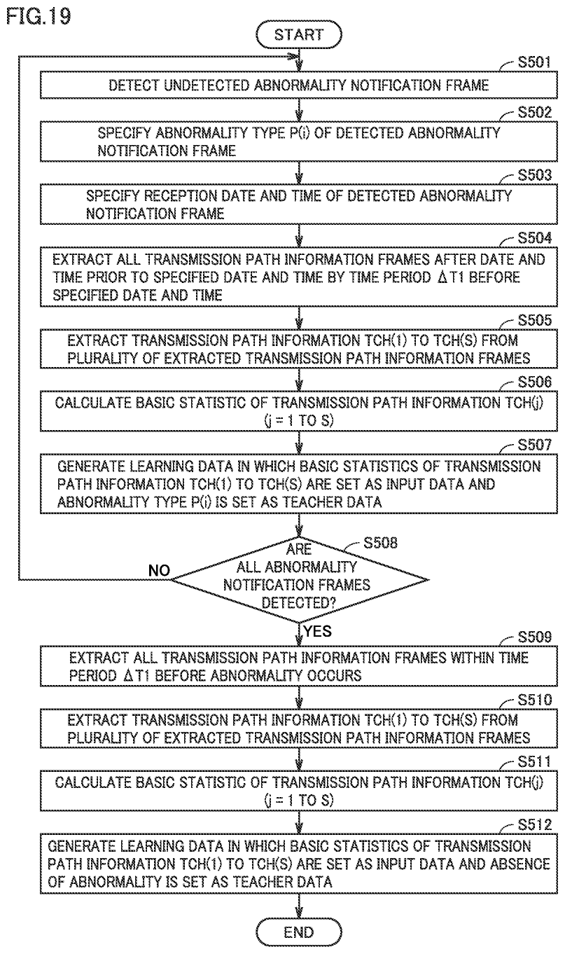

FIG. 19 is a flowchart illustrating a procedure for learning data generation in the third embodiment.

In step S501, a learning data generator 53 detects an undetected abnormality notification frame among communication frames stored in a communication history storage device 52.

In step S502, learning data generator 53 specifies an abnormality type included in the detected abnormality notification frame. The specified abnormality type is defined as abnormality type P(i). i=any of 1 to (L−1).

In step S503, learning data generator 53 specifies a date and time when the detected abnormality notification frame is received.

In step S504, learning data generator 53 extracts all the transmission path information frames after a date and time prior to the specified date and time by a time period ΔT1 before the specified date and time, among the communication frames stored in communication history storage device 52.

In step S505, learning data generator 53 extracts transmission path information TCH(1) to TCH(S) from each of a plurality of extracted transmission path information frames. Transmission path information TCH(1) is a voltage value applied to a transmission path. Transmission path information TCH(2) to TCH(S) are sample values of a waveform of a received communication frame for every certain period of time.

In step S506, learning data generator 53 calculates a basic statistic of a transmission path information TCH(j). Here, j=1 to S.

In step S507, learning data generator 53 generates learning data in which basic statistics of transmission path information TCH(1) to TCH(S) are set as input data X(1) to X(S) to be inputted to the input layer of the abnormality sign estimation model, and specified abnormality type P(i) is set as teacher data of the abnormality sign estimation model.

In a case where all the abnormality notification frames of the communication frames stored in communication history storage device 52 are detected in step S508, the process proceeds to step S509. In a case where there is an undetected communication frame, the process returns to step S501.

In step S509, learning data generator 53 extracts, from the communication frames stored in communication history storage device 52, all the transmission path information frames within time period ΔT1 before the abnormality occurs, that is, before the first abnormality notification frame is received.

In step S510, learning data generator 53 extracts transmission path information TCH(1) to TCH(S) from each of a plurality of extracted transmission path information frames.

In step S511, learning data generator 53 calculates a basic statistic of transmission path information TCH(j). Here, j=1 to S.

In step S512, learning data generator 53 generates learning data in which basic statistics of transmission path information TCH(1) to TCH(S) are set as input data X(1) to X(S) to be inputted to the input layer of the abnormality sign estimation model, and absence of abnormality is set as teacher data of the abnormality sign estimation model.

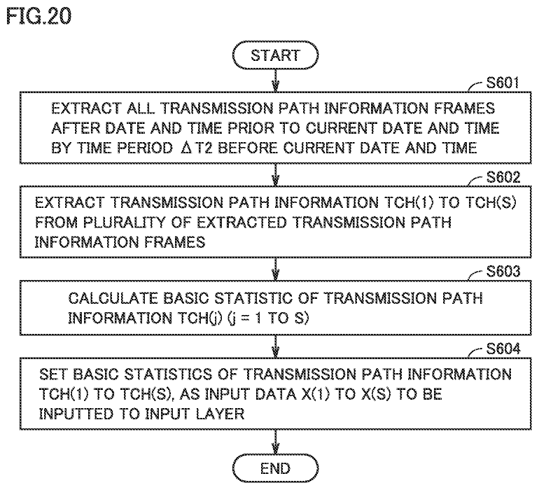

FIG. 20 is a flowchart illustrating a procedure for input data generation in the third embodiment.

In step S601, an input data generator 64 extracts all the transmission path information frames after a date and time prior to a current date and time by a time period ΔT2 before the current date and time, among the communication frames stored in communication history storage device 52.

In step S602, input data generator 64 extracts transmission path information TCH(1) to TCH(S) from each of a plurality of extracted transmission path information frames.

In step S603, input data generator 64 calculates a basic statistic of transmission path information TCH(j). Here, j=1 to S.

In step S604, input data generator 64 sets basic statistics of transmission path information TCH(1) to TCH(S) as input data X(1) to X(S) to be inputted to the input layer of the abnormality sign estimation model.

According to the present embodiment, by using the abnormality sign estimation model in which the basic statistics of transmission path information TCH(1) to TCH(S) are set as input and abnormality sign degrees of abnormality types P(1) to P(L) are set as output, the abnormality sign degree for each abnormality type can be estimated.

### Fourth Embodiment

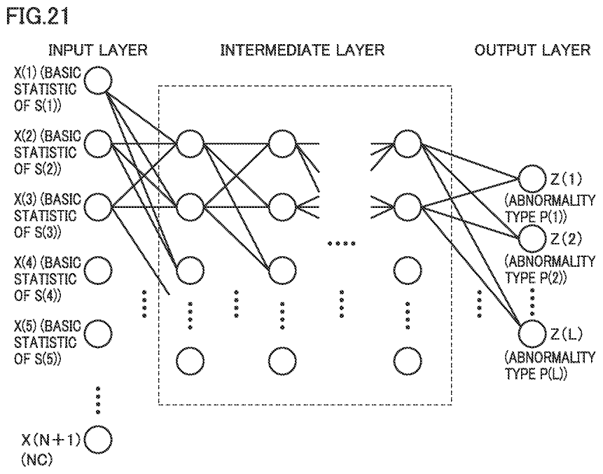

FIG. 21 is a diagram illustrating an abnormality sign estimation model according to a fourth embodiment.

In the abnormality sign estimation model of the present embodiment, input data X(1) to X(N+1) to be inputted to an input layer are basic statistics of sensor information S(1) to S(N) and a total number NC of communication frames within a certain period of time.

At abnormal time, since a change in a control state increases, the number of communication frames to be transmitted increases with the change in the control state. Therefore, by inputting the total number of communication frames within a certain period of time to the input layer of the abnormality sign estimation model, estimation accuracy of an abnormality sign can be improved.

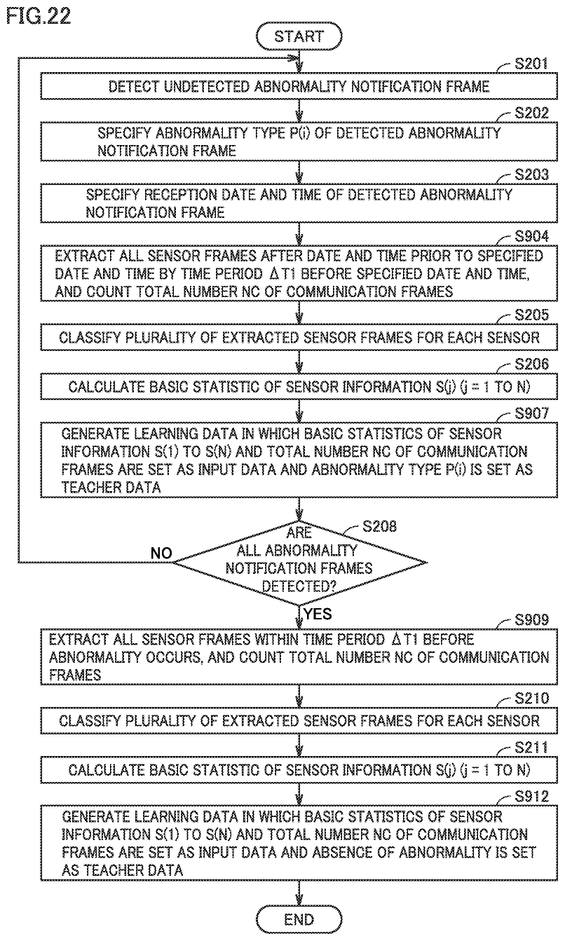

FIG. 22 is a flowchart illustrating a procedure for learning data generation in the fourth embodiment. The flowchart of FIG. 22 is different from the flowchart of the first embodiment of FIG. 9 in that the flowchart of FIG. 22 includes steps S904, S907, S909, and S912 instead of steps S204, S207, S209, and S212.

In step S904, a learning data generator 53 extracts all the sensor frames within a time range after a date and time prior to a specified date and time by a time period ΔT1 before the specified date and time, among communication frames stored in a communication history storage device 52. Further, learning data generator 53 counts total number NC of a plurality of communication frames within the time range.

In step S907, learning data generator 53 generates learning data in which the basic statistics of sensor information S(1) to S(N) and total number NC of communication frames are set as input data X(1) to X(N+1) to be inputted to the input layer of the abnormality sign estimation model, and a specified abnormality type P(i) is set as teacher data of the abnormality sign estimation model.

In step S909, learning data generator 53 extracts, from the communication frames stored in communication history storage device 52, all the sensor frames within a time range of time period ΔT1 before the abnormality occurs, that is, before the first abnormality notification frame is received. Further, learning data generator 53 counts total number NC of a plurality of communication frames within the time range.

In step S912, learning data generator 53 generates learning data in which the basic statistics of sensor information S(1) to S(N) and total number NC of communication frames are set as input data X(1) to X(N+1) to be inputted to the input layer of the abnormality sign estimation model, and absence of abnormality is set as teacher data of the abnormality sign estimation model.

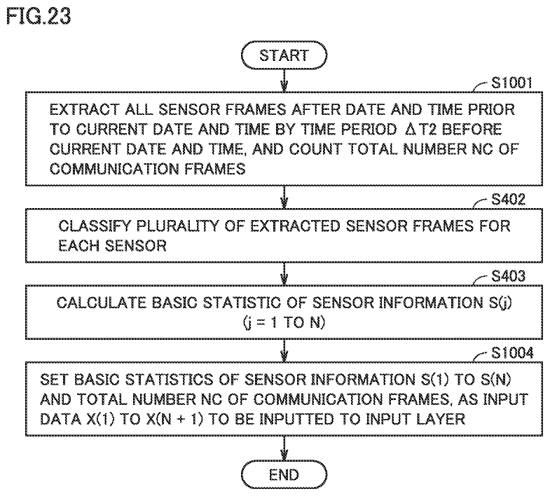

FIG. 23 is a flowchart illustrating a procedure for input data generation in the fourth embodiment. The flowchart of FIG. 23 is different from the flowchart of the first embodiment of FIG. 13 in that the flowchart of FIG. 23 includes steps S1001 and S1004 instead of steps S401 and S404.

In step S1001, an input data generator 64 extracts all the sensor frames within a time range after a date and time prior to a current date and time by a time period ΔT2 before the current date and time, among the communication frames stored in communication history storage device 52. Further, learning data generator 53 counts total number NC of a plurality of communication frames within the time range.

In step S1004, input data generator 64 sets the basic statistics of sensor information S(1) to S(N) and total number NC of communication frames as input data X(1) to X(N+1) to be inputted to the input layer of the abnormality sign estimation model.

According to the present embodiment, by using the abnormality sign estimation model in which the basic statistics of sensor information S(1) to S(N) and the total number of communication frames within a certain period of time are set as input and abnormality sign degrees of abnormality types P(1) to P(L) are set as output, the abnormality sign degree for each abnormality type can be estimated.

Note that, in addition to or instead of the basic statistics of sensor information S(1) to S(N) serving as input of the abnormality sign estimation model, total numbers NST(1) to NST(P) of control states CST(1) to CST(P) included in control state frames within a certain period of time, and/or basic statistics of transmission path information TCH(1) to TCH(S) may be used.

### Fifth Embodiment

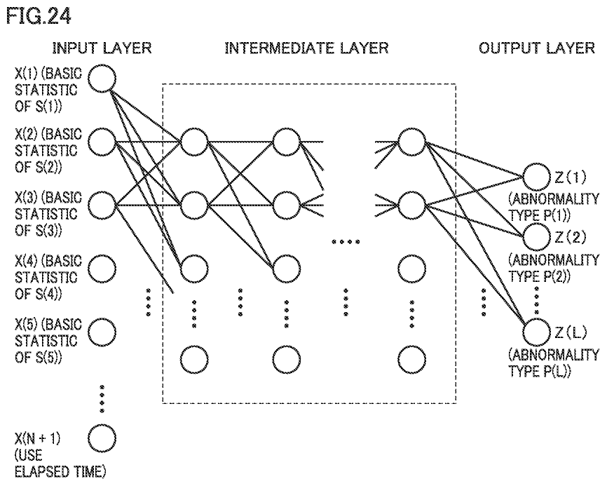

FIG. 24 is a diagram illustrating an abnormality sign estimation model according to a fifth embodiment.

In the abnormality sign estimation model of the present embodiment, input data X(1) to X(N+1) to be inputted to an input layer are basic statistics of sensor information S(1) to S(N) and a use elapsed time. The number of units of the input layer of the abnormality sign estimation model is (N+1).

A use start date and time can be known by using time information included in a time information frame. By inputting an elapsed time from a start of use to the input layer of the abnormality sign estimation model, an abnormality caused by aging deterioration can be accurately estimated.

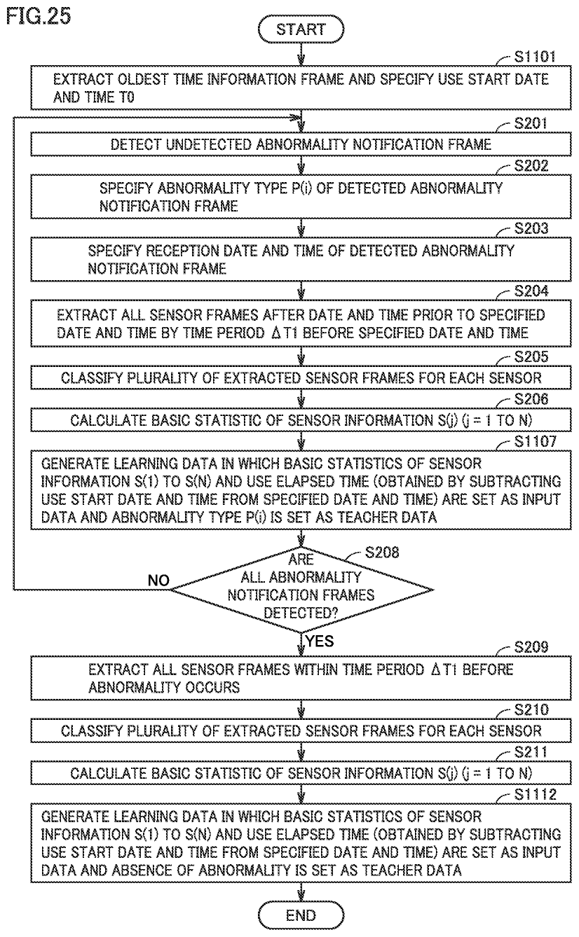

FIG. 25 is a flowchart illustrating a procedure for learning data generation in the fifth embodiment. The flowchart of FIG. 25 is different from the flowchart of the first embodiment of FIG. 9 in that the flowchart of FIG. 25 includes step S1101 and includes steps S1107 and S1112 instead of steps S207 and S212.

In step S1101, a learning data generator 53 detects the oldest time information frame among communication frames stored in communication history storage device 52. Learning data generator 53 specifies a date and time included in the time information frame as a use start date and time T0 of an air conditioner.

In step S1107, learning data generator 53 sets, as the use elapsed time, a difference between a reception date and time of an abnormality notification frame (the specified date and time in step S203) and use start date and time T0 of the air conditioner. Learning data generator 53 generates learning data in which the basic statistics of sensor information S(1) to S(N) and the use elapsed time are set as input data X(1) to X(N+1) to be inputted to the input layer of the abnormality sign estimation model, and a specified abnormality type P(i) is set as teacher data of the abnormality sign estimation model.

In step S1112, learning data generator 53 sets, as the use elapsed time, a difference between a latest date and time within a time period ΔT1 before occurrence of the abnormality and use start date and time T0 of the air conditioner. Learning data generator 53 generates learning data in which the basic statistics of sensor information S(1) to S(N) and the use elapsed time are set as input data X(1) to X(N+1) to be inputted to the input layer of the abnormality sign estimation model, and absence of abnormality is set as teacher data of the abnormality sign estimation model.

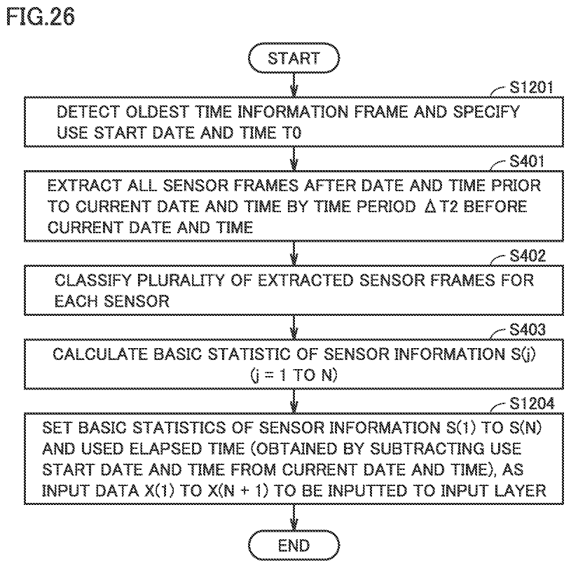

FIG. 26 is a flowchart illustrating a procedure for input data generation in the fifth embodiment. The flowchart of FIG. 26 is different from the flowchart of the first embodiment of FIG. 13 in that the flowchart of FIG. 26 includes step S1201 and includes step S1204 instead of step S404.

In step S1201, an input data generator 64 detects the oldest time information frame among communication frames stored in communication history storage device 52. Input data generator 64 specifies a date and time included in the time information frame as use start date and time T0 of the air conditioner.

In step S1204, input data generator 64 sets, as the use elapsed time, a difference between a current date and time and use start date and time T0 of the air conditioner. Input data generator 64 sets basic statistics of detection values of sensor information S(1) to S(N) and the used elapsed time, as input data X(1) to X(N+1) to be inputted to the input layer of the abnormality sign estimation model.

According to the present embodiment, by using the abnormality sign estimation model in which the basic statistics of sensor information S(1) to S(N) and the use elapsed time are set as input and abnormality sign degrees of abnormality types P(1) to P(L) are set as output, the abnormality sign degree for each abnormality type can be estimated.

Note that, instead of the use elapsed time serving as input of the abnormality sign estimation model, it is possible to use time information in a time information frame transmitted in a time zone in which sensor frames including sensor information S(1) to S(N) are transmitted. An abnormal content varies depending on a season and a time zone, such as a case where an abnormality due to malfunction of a refrigeration cycle is likely to occur in early morning operation in a winter season due to a refrigerant pipe being frozen and the like. Therefore, by using time information as input of the abnormality sign estimation model, it is possible to more accurately estimate an abnormality sign.

Note that, in addition to or instead of the basic statistics of sensor information S(1) to S(N) serving as input of the abnormality sign estimation model, total numbers NST(1) to NST(P) of control states CST(1) to CST(P) included in control state frames within a certain period of time, and/or basic statistics of transmission path information TCH(1) to TCH(S) may be used.

### Sixth Embodiment

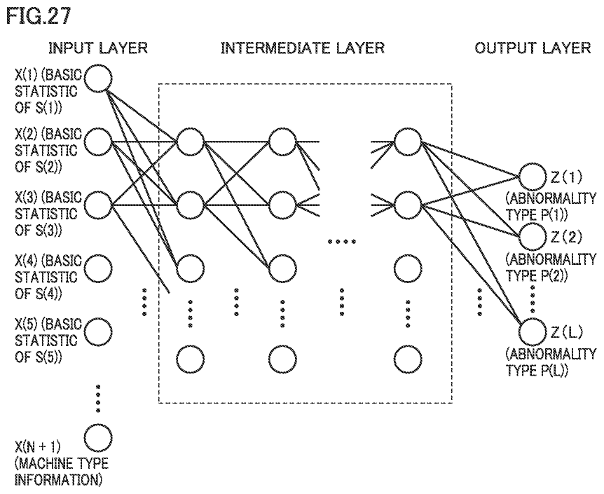

FIG. 27 is a diagram illustrating an abnormality sign estimation model according to a sixth embodiment.

In the abnormality sign estimation model of the present embodiment, input data X(1) to X(N+1) to be inputted to an input layer are basic statistics of sensor information S(1) to S(N) and machine type information.

Different machine types of an air conditioner 20 have different types of abnormalities that are likely to occur due to different component configurations. For example, in a case where only a specific machine type has a sensor susceptible to failure, an abnormality sign regarding the failure of the sensor can be estimated more correctly by inputting sensor information and machine type information to the input layer of the abnormality sign estimation model.

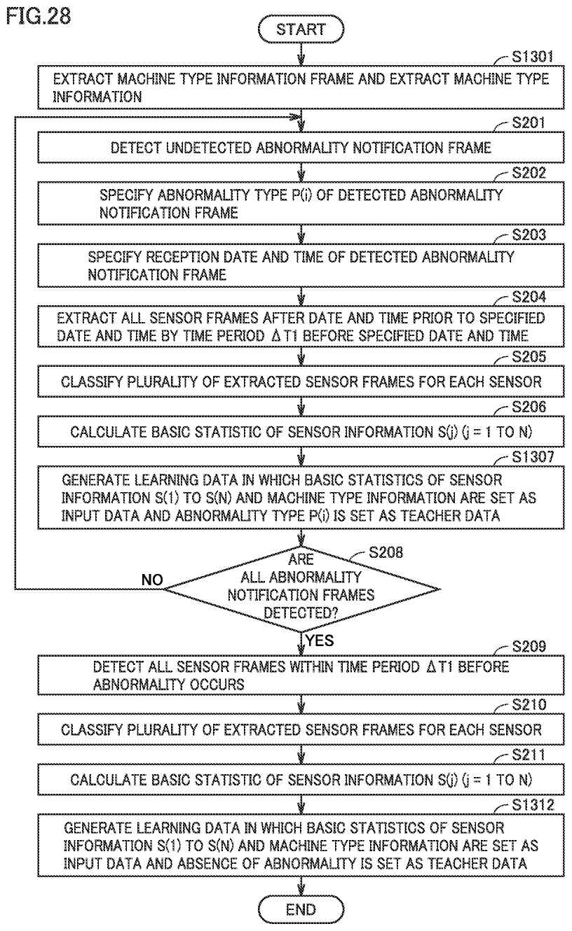

FIG. 28 is a flowchart illustrating a procedure for learning data generation in the sixth embodiment. The flowchart of FIG. 28 is different from the flowchart of the first embodiment of FIG. 9 in that the flowchart of FIG. 28 includes step S1301 and includes steps S1307 and S1312 instead of steps S207 and S212.

In step S1301, a learning data generator 53 detects a machine type information frame among communication frames stored in a communication history storage device 52. Learning data generator 53 extracts machine type information included in the machine type information frame.

In step S1307, learning data generator 53 generates learning data in which the basic statistics of sensor information S(1) to S(N) and the machine type information are set as input data X(1) to X(N+1) to be inputted to the input layer of the abnormality sign estimation model, and a specified abnormality type P(i) is set as teacher data of the abnormality sign estimation model.

In step S1312, learning data generator 53 generates learning data in which the basic statistics of sensor information S(1) to S(N) and the machine type information are set as input data X(1) to X(N+1) to be inputted to the input layer of the abnormality sign estimation model, and absence of abnormality is set as teacher data of the abnormality sign estimation model.

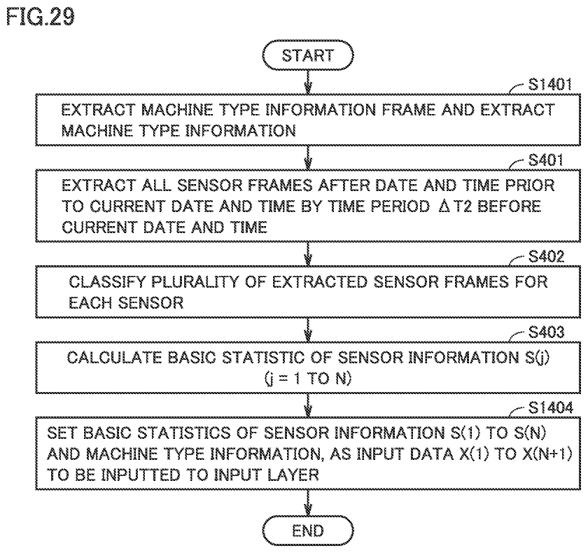

FIG. 29 is a flowchart illustrating a procedure for input data generation in the sixth embodiment. The flowchart of FIG. 29 is different from the flowchart of the first embodiment of FIG. 13 in that the flowchart of FIG. 29 includes step S1401 and includes step S1404 instead of step S404.

In step S1401, an input data generator 64 detects a machine type information frame among communication frames stored in communication history storage device 52. Input data generator 64 extracts machine type information included in the machine type information frame.

In step S1404, input data generator 64 sets the basic statistics of sensor information S(1) to S(N) and the machine type information as input data X(1) to X(N+1) to be inputted to the input layer of the abnormality sign estimation model.

According to the present embodiment, by using the abnormality sign estimation model in which the basic statistics of sensor information S(1) to S(N) and the machine type information are set as input and abnormality sign degrees of abnormality types P(1) to P(L) are set as output, the abnormality sign degree for each abnormality type can be estimated.

Note that, in addition to or instead of the basic statistics of sensor information S(1) to S(N) serving as input of the abnormality sign estimation model, total numbers NST(1) to NST(P) of control states CST(1) to CST(P) included in control state frames within a certain period of time, time information, and/or basic statistics of transmission path information TCH(1) to TCH(S) may be used.

For example, control of a refrigeration cycle may be different depending on a software version. Therefore, by inputting the total number of control states associated with a change in a control state and machine type information to the input layer of the abnormality sign estimation model, an abnormality sign of malfunction of the refrigeration cycle can be correctly estimated.

Modifications.

The present disclosure is not limited to the embodiments described above, and includes, for example, modifications as follows.

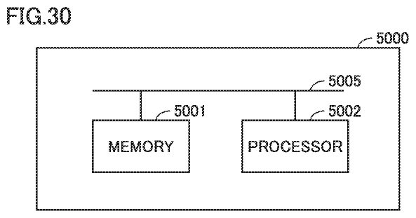

(1) In the abnormality sign estimation model learning device or the abnormality sign estimation device described in the first to sixth embodiments, corresponding operation can be configured by hardware of a digital circuit or software. In a case where the function of the abnormality sign estimation model learning device or the abnormality sign estimation device is realized by using software, the abnormality sign estimation model learning device or the abnormality sign estimation device can include, for example, a processor 5002 and a memory 5001 as illustrated in FIG. 30, and processor 5002 can execute a program stored in memory 5001.

(2) A maintenance tool is a device for checking an installation state or an operation state of the air conditioner. In order for an installation worker of the air conditioner to use the maintenance tool to confirm that installation has been properly performed, a communication frame including machine type information as part of installation information can be transmitted from the maintenance tool to the outdoor unit, the indoor unit, the remote controller, an abnormality sign estimator, or the like. The abnormality sign estimation model learning device and the abnormality sign estimation device may receive the communication frame and extract the machine type information.

(3) The abnormality sign estimation model learning device and the abnormality sign estimation device may request the outdoor unit, the indoor unit, and the remote controller to transmit a sensor frame, a device control frame, a device state frame, a control state frame, a transmission path information frame, a machine type information frame, and/or a time information frame, may receive these communication frames transmitted in response to the request, and may store the communication frames as a communication history.

(4) In the embodiments described above, one abnormality sign degree is estimated for one sensor, and one abnormality sign degree is estimated for one device, but the present invention is not limited thereto. A plurality of types of abnormality sign degrees may be estimated for one sensor, and a plurality of types of abnormality sign degrees may be estimated for one device. For example, for one sensor, two types of abnormality sign degrees of “sensor failure due to aging deterioration” and “sensor value abnormality due to connector contact failure” may be estimated.

(5) In the embodiments described above, the abnormality sign estimation model learned using a communication frame transmitted in an air conditioner A is used to estimate the abnormality sign for each abnormality type of the same air conditioner A, but the present invention is not limited thereto.

An abnormality sign estimation model learned using a communication frame transmitted by another air conditioner B may be acquired, and an abnormality sign degree may be estimated for each abnormality type of air conditioner A on the basis of the acquired abnormality sign estimation model.

The abnormality sign estimation model learning device may generate learning data by using communication frames transmitted in a plurality of air conditioners in the same area. The abnormality sign estimation model learning device may generate learning data by using communication frames transmitted in a plurality of air conditioners that operate independently in different areas.

The air conditioner to which a communication frame used for learning an abnormality sign estimation model is transmitted may be switched, added, or removed in the middle of learning. Further, when the abnormality sign estimation model learned using a communication frame transmitted in a certain air conditioner A is used to estimate an abnormality sign degree of another air conditioner B, the learned abnormality sign estimation model may be relearned by using a communication frame transmitted in another air conditioner B.

(6) The abnormality sign estimation model learning device may perform learning by using all the communication histories stored in the communication history storage device, that is, communication histories from the start of use of the air conditioner to the present. Alternatively, the abnormality sign estimation model learning device may perform learning by using communication histories from a certain period of time before to the present stored in the communication history storage device. An amount of data used for learning may be freely set in accordance with a computation capability of the abnormality sign estimation model learning device.

(7) As a basic statistic of sensor information, an average value, a variance value, a standard deviation value, skewness, kurtosis, a minimum value, a maximum value, a median value, a mode, or a total value of detection values of the sensors can be used. Alternatively, any combination of these may be used as the basic statistic of the sensor information. In a case where M pieces of these are set as the basic statistics, the basic statistics of the M×N pieces of sensor information are inputted to an input layer of a neural network. For example, when the average value and the variance value are used as the basic statistics of the sensor information, the average value and the variance value of a sensor S(j) are inputted to the input layer of the neural network. Note that j=1 to N.

This similarly applies to basic statistics of the transmission path information.

(8) In the embodiments described above, a basic statistic of the sensor information or a basic statistic of the transmission path information is used as input of the abnormality sign estimation model, but the sensor information itself or the transmission path information itself may be used as input of the abnormality sign estimation model.

(9) The abnormality sign estimation model learning device and the abnormality sign estimation device may exist on a cloud server.

(10) In the embodiments described above, a case where supervised learning is applied as the learning algorithm used by the model generator has been described, but the present invention is not limited thereto. In addition to the supervised learning, reinforcement learning, unsupervised learning, semi-supervised learning, or the like can be applied to the learning algorithm. As a learning algorithm used in the model generator, deep learning for learning extraction of a feature amount itself may be used, or other known methods such as genetic programming, functional logic programming, or a support vector machine may be used.

It is to be understood that the embodiments that have been disclosed herein are not restrictive, but are illustrative in all respects. The scope of the present disclosure is defined not by the description above but by the claims, and it is intended to include all modifications within the meaning and scope equivalent to the claims.

1. An abnormality sign estimation model learning device for an air conditioner including an outdoor unit, an indoor unit, and a remote controller, the abnormality sign estimation model learning device comprising:
a communication circuit to receive a communication frame transmitted between the outdoor unit, the indoor unit, and the remote controller;
a communication history storage device to store the received communication frame;
a learning data generator to generate learning data by using a communication frame stored in the communication history storage device; and
a model generator to learn an estimation model for estimation of an abnormality sign degree for each abnormality type of the air conditioner by using the generated learning data.

2. The abnormality sign estimation model learning device for an air conditioner according to claim 1, wherein
the communication frame includes an abnormality notification frame, and
the learning data generator generates teacher data of the learning data by using information indicating an abnormality type included in the abnormality notification frame stored in the communication history storage device.

3. The abnormality sign estimation model learning device for an air conditioner according to claim 1, wherein
the communication frame includes a sensor frame, and
the learning data generator generates input data of the learning data by using a detection value of a sensor included in the sensor frame stored in the communication history storage device.

4. The abnormality sign estimation model learning device for an air conditioner according to claim 3, wherein the learning data generator calculates a basic statistic of a detection value of each of a plurality of the sensors, the detection value being included in a plurality of the sensor frames within a certain period of time, and the learning data generator generates input data of the learning data by using a plurality of the calculated basic statistics.

5. The abnormality sign estimation model learning device for an air conditioner according to claim 1, wherein
the communication frame includes a control state frame, and
the learning data generator generates input data of the learning data by using information indicating a control state included in the control state frame stored in the communication history storage device.

6. The abnormality sign estimation model learning device for an air conditioner according to claim 5, wherein the learning data generator generates input data of the learning data by using a total number of each of a plurality of the control states included in a plurality of the control state frames within a certain period of time.

7. The abnormality sign estimation model learning device for an air conditioner according to claim 1, wherein
the communication frame includes a transmission path information frame, and
the learning data generator generates input data of the learning data by using transmission path information included in the transmission path information frame stored in the communication history storage device.

8. The abnormality sign estimation model learning device for an air conditioner according to claim 3, wherein the learning data generator generates input data of the learning data by further using a total number of communication frames within a certain period of time stored in the communication history storage device.

9. The abnormality sign estimation model learning device for an air conditioner according to claim 3, wherein
the communication frame includes a time information frame, and
the learning data generator generates input data of the learning data by further using time information included in the time information frame stored in the communication history storage device.

10. The abnormality sign estimation model learning device for an air conditioner according to claim 3, wherein
the communication frame includes a machine type information frame, and
the learning data generator generates input data of the learning data by further using machine type information included in the machine type information frame stored in the communication history storage device.

11. An abnormality sign estimation device for an air conditioner including an outdoor unit, an indoor unit, and a remote controller, the abnormality sign estimation device comprising:
a communication circuit to receive a communication frame transmitted between the outdoor unit, the indoor unit, and the remote controller;
a communication history storage device to store the received communication frame;
an input data generator to generate input data of an estimation model for estimation of an abnormality sign degree for each abnormality type of the air conditioner, by using a communication frame stored in the communication history storage device; and
an estimator to estimate an abnormality sign degree for each abnormality type of the air conditioner by using the input data and the estimation model that has been learned.

12. The abnormality sign estimation device for an air conditioner according to claim 11, wherein
the communication frame includes a sensor frame, and
the input data generator generates the input data by using a detection value of a sensor included in the sensor frame stored in the communication history storage device.

13. The abnormality sign estimation device for an air conditioner according to claim 12, wherein the input data generator calculates a basic statistic of a detection value of each of a plurality of the sensors, the detection value being included in a plurality of the sensor frames within a certain period of time, and the input data generator generates the input data by using a plurality of the calculated basic statistics.

14. The abnormality sign estimation device for an air conditioner according to claim 11, wherein
the communication frame includes a control state frame, and
the input data generator generates the input data by using information indicating a control state included in the control state frame stored in the communication history storage device.

15. (canceled)

16. The abnormality sign estimation device for an air conditioner according to claim 11, wherein
the communication frame includes a transmission path information frame, and
the input data generator generates the input data by using transmission path information included in the transmission path information frame stored in the communication history storage device.

17. The abnormality sign estimation device for an air conditioner according to claim 12, wherein the input data generator generates the input data by further using a total number of communication frames within a certain period of time stored in the communication history storage device.

18. The abnormality sign estimation device for an air conditioner according to claim 12, wherein
the communication frame includes a time information frame, and
the input data generator generates the input data by further using time information included in the time information frame stored in the communication history storage device.

19. The abnormality sign estimation device for an air conditioner according to claim 12, wherein
the communication frame includes a machine type information frame, and
the input data generator generates the input data by further using machine type information included in the machine type information frame stored in the communication history storage device.

20. The abnormality sign estimation device for an air conditioner according to claim 11, further comprising an abnormality processing device to execute a process for abnormality avoidance, based on an estimation result of an abnormality sign degree for each the abnormality type.

21. An air conditioner comprising:
an outdoor unit, an indoor unit, and a remote controller;
an abnormality sign estimation model learning device; and
an abnormality sign estimation device;
the abnormality sign estimation model learning device comprising:
a communication circuit to receive a communication frame transmitted between the outdoor unit, the indoor unit, and the remote controller;
a communication history storage device to store the received communication frame;
a learning data generator to generate learning data by using a communication frame stored in the communication history storage device; and
a model generator to learn an estimation model for estimation of an abnormality sign degree for each abnormality type of the air conditioner by using the generated learning data,
the abnormality sign estimation device comprising:
a communication circuit to receive a communication frame transmitted between the outdoor unit, the indoor unit, and the remote controller;
a communication history storage device to store the received communication frame;
an input data generator to generate input data of an estimation model for estimation of an abnormality sign degree for each abnormality type of the air conditioner, by using a communication frame stored in the communication history storage device; and
an estimator to estimate an abnormality sign degree for each abnormality type of the air conditioner by using the input data and the estimation model that has been learned.
